(19) United States
(12) Patent Application Publication
(10) Pub. No.: US 2012/0050309 A1
(43) Pub. Date: Mar. 1, 2012

(54) DISPLAY CONTROL APPARATUS AND DISPLAY CONTROL METHOD

(75) Inventors: Ryusuke Tsuchida, Tokyo (JP); Akira Ueno, Tokyo (JP)

(73) Assignee: OLYMPUS CORPORATION, Tokyo (JP)

(21) Appl. No.: 13/220,069

(22) Filed: Aug. 29, 2011

(30) Foreign Application Priority Data
Aug. 31, 2010 (JP) 2010-194853

(51) Int. Cl. G09G 5/02

(52) U.S. Cl. 345/592

(57) ABSTRACT

A display control apparatus may include: an area determination unit that determines a boundary position of a superimposition image based on transparency information; a color extension unit that extends an area of color information based on the boundary position determined by the area determination unit; a transparency conversion unit that converts information of pixels, which are to be processed as non-transparent pixels, in the transparency information based on the boundary position determined by the area determination unit; and an image superimposition unit that superimposes color information after the extension color information output by the color extension unit is filtered based on the transparency conversion information.

### BACKGROUND OF THE INVENTION

1. Field of the Invention

The present invention relates to a display control apparatus and a display control method.

Priority is claimed on Japanese Patent Application No. 2010-194853, filed Aug. 31, 2010, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

An image display control block, which is embedded in a system LSI or image processing LSI mounted on an image pick-up device such as a still-image camera, a moving-image camera, a medical endoscope camera, or an industrial endoscope camera, controls a color or brightness of an image displayed on a display device such as a liquid crystal display (LCD) and causes a character image to be superimposed and displayed on a background image. In this case, the image display control block generates a display image in which the background image is synthesized with the character image by superimposing the character image on the background image, and outputs an image signal of the generated display image to the display device (see Japanese Unexamined Patent Application, First Publication No. 2002-351439). Because the display image can use the same image data in the background image, for example, even when the character image is varied, the entire amount of image data can be reduced.

The image synthesis as described above can be implemented by providing transparency information as well as color information as the character image. Here, the color information has data indicating a pixel color (hereinafter referred to as “color data”) for each pixel of a character portion, and the transparency information indicates whether or not each pixel of the same rectangular image as the background image is transparent (or semi-transparent in some cases). It is possible to highlight a character having a complex shape on a background by superimposing the character image on the background image based on the color information and the transparency information. That is, an image in which color data of a pixel indicated to be transparent by the transparency information is designated as color data of the background image and color data of a pixel indicated to be non-transparent is designated as color data of the character image is generated as a display image in which the background image is synchronized with the character image.

FIG. 12 is a diagram schematically showing an example in which a display image is generated by synthesizing a background image with a character image. FIG. 12 shows necessary image data and information when a synthesized display image is generated. FIG. 12(a) shows the background image, FIG. 12(b) shows color information of the character image and transparency information of the character image, and FIG. 12(c) shows the display image after the synthesis. In the transparency information of the character image shown in FIG. 12(b), a black pixel area is a pixel area of a transparent portion, and a white pixel area is a pixel area of a non-transparent portion. In the generation of the display image in which the background image is synthesized with the character image as shown in FIG. 12, the background image is made transparent by setting the pixel area of the transparent portion indicated in black in the transparency information to the color data of the background image, and the character image is synthesized by setting the pixel area of the non-transparent portion indicated in white to color data of a character included in the color information.

However, if the display image in which the background image is synthesized with the character image is displayed, a false color such as a color different from that of FIG. 12(c) appears in pixels of a boundary portion between the character image and the background image in the display image because there is no correlation with the color information of the background image and the color information of the character image. To reduce the occurrence of false colors when the display image is displayed on the display device, the image display control block performs a filter process using a low pass filter (LPF). It is preferable to separately filter the background image and the character image in the filter process. However, it is necessary to filter the display image after the synthesis without separately filtering the background image and the character image so as to reduce the number of false colors occurring in the boundary portion between the character image and the background image.

FIG. 13 is a diagram schematically showing an example of the related art when the background image and the character image are separately filtered before the display image is generated by synthesizing the background image with the character image. FIG. 13 shows necessary image data and information when the synthesized display image is generated as in the example in which the display image shown in FIG. 12 is generated. In this regard, color information after a filter process is performed using a 3-tap LPF in a horizontal direction is shown in color information of the character image shown in FIG. 13(b) in relation to the color information shown in FIG. 12(b). If only the character image is filtered, a false color also appears in a boundary portion of the character image as shown in FIG. 13(b). As in the generation of the display image shown in FIG. 12, the false color of the character image is displayed in the boundary portion between the character image and the background image in the display image as shown in FIG. 13(c), if the background image is synthesized with the character image by making the background image transparent in the pixel area of the transparent portion indicated in black in the transparency information and setting the pixel area of the non-transparent portion indicated in white to color data of a character included in the color information. The false colors may also be caused by a correlation between the color information of the background image and the color information of the character image.

Within the false color in the character image, a false color in the boundary portion between the character image and the background image is a new false color occurring in pixels of the boundary portion between the pixel area of the transparent portion and the pixel area of the non-transparent portion in the character image by performing a filter process for the character image. That is, although the color information of the character is identical in the example of the generation of the display image shown in FIG. 12 and the example of the generation of the display image shown in FIG. 13, that is, although the color information shown in FIG. 12(b) is the same as the color information before the filter process in FIG. 13(b), the color data of the character becomes different because a pixel area where there is the color data of the character and a pixel area where there is no color data of the character are filtered by performing a filter process for the color information of the character image in the example of the generation of the display image shown in FIG. 13. As shown in FIG. 13(b), new color data is also generated in a pixel area where there is no color data.

As described above, if a filter process used as a technique for reducing the false color occurring when the display image is displayed on the display device is performed for a character image configured by the color information and the transparency information, a new false color due to a filter process for the character image appears in pixels located in the boundary portion between the character image and the background image in the display image, that is, the boundary portion between the pixel area of the transparent portion and the pixel area of the non-transparent portion.

A false color due to the absence of a correlation with color information of two images appears in a boundary portion between the background image and the character image, that is, a boundary portion between the pixel area of the transparent portion and the pixel area of the non-transparent portion in the character image, by performing a separate filter process for each image before the background image is synthesized with the character image.

### SUMMARY

The present invention provides a display control apparatus and method capable of superimposing a character image on a background image without displaying (or outputting) a false color occurring in pixels located in a boundary portion between a pixel area of a transparent portion and a pixel area of a non-transparent portion of the character image even when a separate filter process is performed for the background image and the character image.

A display control apparatus may include: an area determination unit that determines a boundary position of a superimposition image based on transparency information, the transparency information indicating whether or not each pixel, which is included in the superimposition image, is processed as a transparent pixel, the superimposition image being superimposed on a background image; a color extension unit that extends an area of color information based on the boundary position determined by the area determination unit, the color information indicating a color of each pixel that is included in the superimposition image, the color extension unit outputting extension color information that has been extended; a transparency conversion unit that converts information of pixels, which are to be processed as non-transparent pixels, in the transparency information based on the boundary position determined by the area determination unit, the transparency conversion unit outputting transparency conversion information including the information that has been converted; and an image superimposition unit that superimposes color information after the extension color information output by the color extension unit is filtered based on the transparency conversion information, the image superimposition unit outputting a superimposed image as a display image.

The area determination unit may divide pixels within the superimposition image into a transparent area to be processed as transparent pixels and a non-transparent area to be processed as non-transparent pixels based on the transparency information, and the area determination unit may determine a boundary position between the transparent area and the non-transparent area within the superimposition image. The color extension unit may extend an area of color information of each pixel within the superimposition image by converting a color of a pixel of the superimposition image within the transparent area adjacent to the boundary position into a color of a pixel of the superimposition image within the non-transparent area adjacent to the boundary position. The transparency conversion unit may convert information of a pixel of the superimposition image within the non-transparent area adjacent to the boundary position in the transparency information into information to be processed as a semi-transparent pixel based on predetermined conversion information. The image superimposition unit may directly set a color of a pixel indicated to be processed as a transparent pixel by the transparency conversion information to a color of a corresponding pixel in the filtered background image, convert a color of a pixel indicated to be processed as a non-transparent pixel by the transparency conversion information into a color of a corresponding pixel in the filtered extension color information, and superimpose the superimposition image on the background image by converting a color of a pixel indicated to be processed as a semi-transparent pixel by the transparency conversion information into a color based on a color of a corresponding pixel in the filtered background image and a color of a corresponding pixel in the filtered extension color information.

The image superimposition unit may include: a first low pass filter (LPF) that performs a filtering process on the background image; and a second LPF that performs a filtering process on the extension color information. The color extension unit may decide the number of pixels of the superimposition image to be extended based on the number of taps of the second LPF provided in the image superimposition unit, and convert a color of pixels corresponding to the decided number and including a pixel of the superimposition image within the transparent area adjacent to the boundary position into a color of pixels of the superimposition image within the non-transparent area adjacent to the boundary position.

The transparency information may include information indicating whether or not each pixel within the superimposition image is processed as a semi-transparent pixel, and the area determination unit may designate a pixel indicated to be processed as the semi-transparent pixel by the transparency information as a non-transparent pixel, and determine a boundary position between the transparent area and the non-transparent area including the semi-transparent pixel.

The second LPF may perform a filter process in a horizontal direction of the superimposition image. The color extension unit may extend an area of color information of each pixel within the superimposition image in the horizontal direction by converting a color of a pixel of the horizontal direction in the superimposition image within the transparent area adjacent to the boundary position into a color of a pixel of the horizontal direction in the superimposition image within the non-transparent area adjacent to the boundary position.

The second LPF may perform a filter process in a vertical direction of the superimposition image. The color extension unit may extend an area of color information of each pixel within the superimposition image in the vertical direction by converting a color of a pixel of the vertical direction in the superimposition image within the transparent area adjacent to the boundary position into a color of a pixel of the vertical direction in the superimposition image within the non-transparent area adjacent to the boundary position.

The transparency conversion unit may convert the information of pixels, which are to be processed as non-transparent pixels, in the transparency information into information to be processed as semi-transparent pixels based on the boundary position determined by the area determination unit, and the transparency conversion unit may output the transparency conversion information including the information that has been converted.

The image superimposition unit may superimpose the color information after the extension color information output by the color extension unit is filtered on a background image after the background image is filtered based on the transparency conversion information, and the image superimposition unit may output the superimposed image as the display image.

A display control method may include: an area determination step of determining a boundary position of a superimposition image based on transparency information indicating whether or not each pixel to be included in the superimposition image to be superimposed on a background image is processed as a transparent pixel; a color extension step of extending an area of color information indicating a color of each pixel to be included in the superimposition image based on the boundary position determined by the area determination step, and outputting extended extension color information; a transparency conversion step of converting information of pixels to be processed as non-transparent pixels in the transparency information into information to be processed as semi-transparent pixels based on the boundary position determined by the area determination step, and outputting transparency conversion information including the converted information; and an image superimposition step of superimposing color information after the extension color information output by the color extension step is filtered on a background image after the background image is filtered based on the transparency conversion information, and outputting a superimposed image as a display image.

According to the present invention, it is possible to superimpose a character image on a background image without displaying (or outputting) a false color occurring in pixels located in a boundary portion between a pixel area of a transparent portion and a pixel area of a non-transparent portion of the character image even when a separate filter process is performed for the background image and the character image.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram showing a schematic configuration of an image pick-up device in accordance with a first preferred embodiment of the present invention;

FIG. 2 is a block diagram showing a schematic configuration of a display control block included in the image pick-up device in accordance with the first preferred embodiment of the present invention;

FIGS. 3 (a)-(d) are diagrams illustrating a first color information generation method of generating color information of a character image before a filter process in the display control block in accordance with the first preferred embodiment of the present invention;

FIGS. 4 (a)-(c) are diagrams schematically showing an example of color information of a character image generated in the first color information generation method by the display control block in accordance with the first preferred embodiment of the present invention;

FIGS. 5 (a)-(c) are diagrams schematically showing an example in which a display image is generated by synthesizing a background image with a character image generated by the first color information generation method in the display control block in accordance with the first preferred embodiment of the present invention;

FIGS. 6 (a)-(d) are diagrams illustrating a second color information generation method of generating color information of a character image before a filter process in the display control block in accordance with the first preferred embodiment of the present invention;

FIGS. 7 (a)-(c) are diagrams schematically showing an example of color information of a character image generated in the second color information generation method by the display control block in accordance with the first preferred embodiment of the present invention;

FIGS. 8 (a)-(c) are diagrams schematically showing an example in which a display image is generated by synthesizing a background image with a character image generated by the second color information generation method in the display control block in accordance with the first preferred embodiment of the present invention;

FIGS. 9 (a)-(b) are diagrams illustrating a method of generating the transparency information of a character image in the display control block in accordance with the first preferred embodiment of the present invention;

FIGS. 10 (a)-(b) are diagrams schematically showing an example of transparency information of a character image generated in a transparency information generation method by the display control block in accordance with the first preferred embodiment of the present invention;

FIGS. 11 (a)-(c) are diagrams schematically showing an example in which a display image is generated by synthesizing the background image with the character image obtained by processing transparency information in the display control block in accordance with the first preferred embodiment of the present invention;

FIGS. 12 (a)-(c) are diagrams schematically showing an example in which a display image is generated by synthesizing a background image with a character image; and

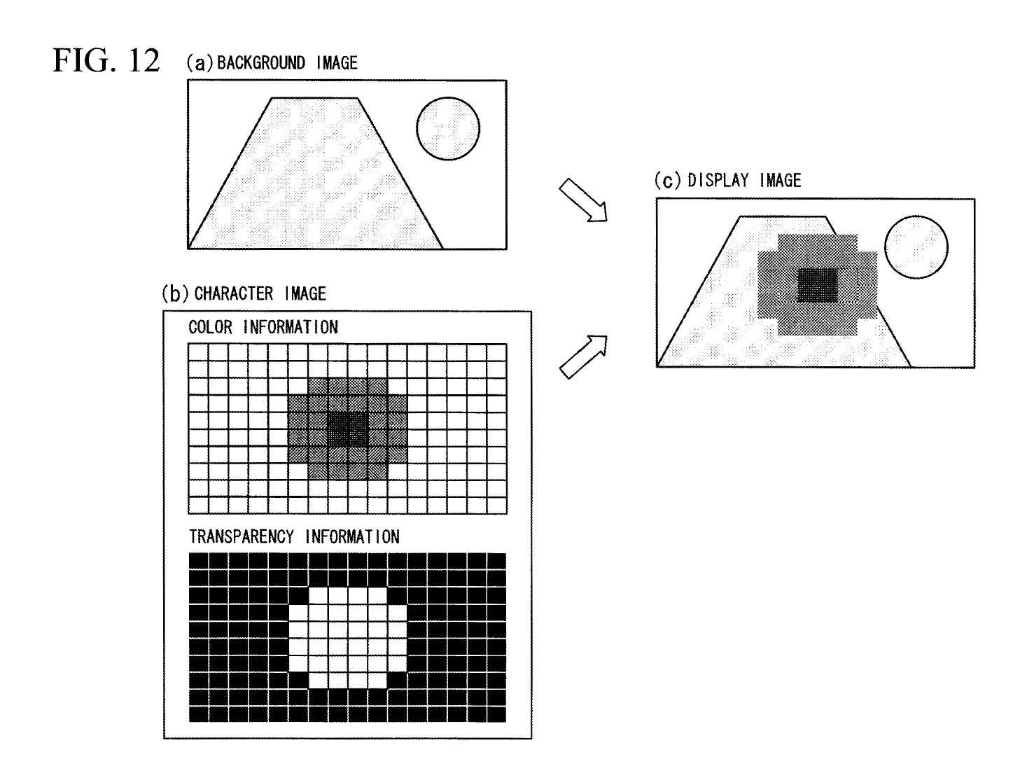

FIGS. 13 (a)-(c) are diagrams schematically showing an example when the background image and the character image are separately filtered before the display image is generated by synthesizing the background image with the character image in accordance with the related art.

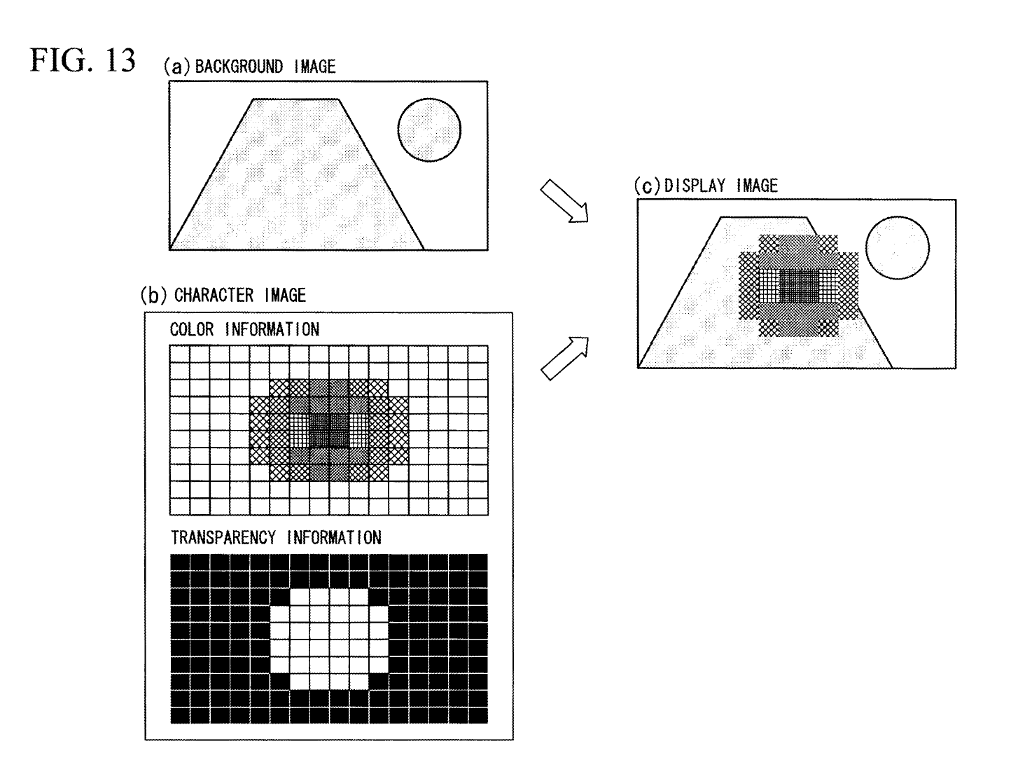

### DETAILED DESCRIPTION OF THE PREFERRED EMBODIMENTS

The present invention will be now described herein with reference to illustrative preferred embodiments. Those skilled in the art will recognize that many alternative preferred embodiments can be accomplished using the teaching of the present invention and that the present invention is not limited to the preferred embodiments illustrated for explanatory purpose.

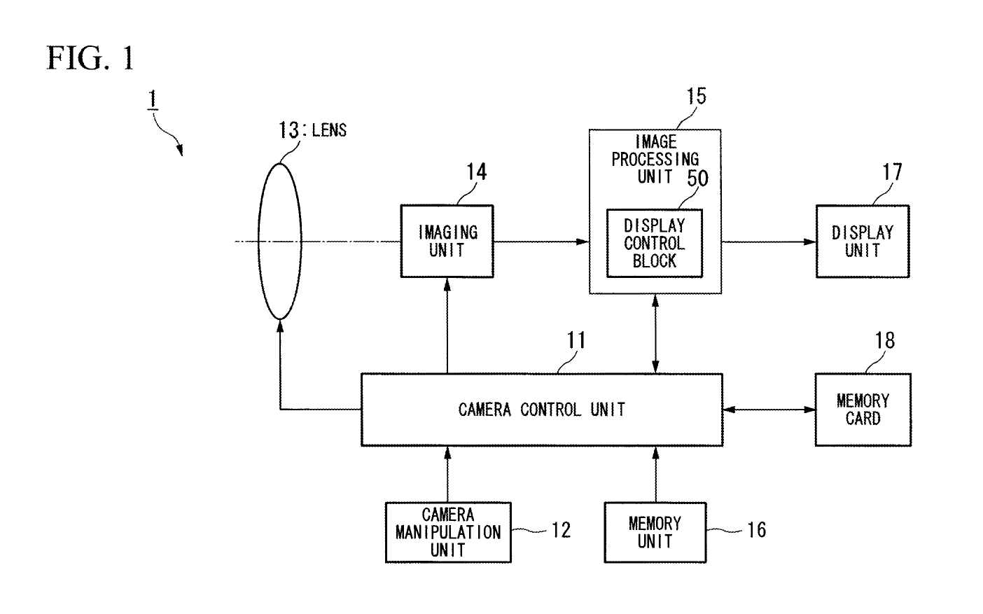

FIG. 1 is a block diagram showing a schematic configuration of an image pick-up device in accordance with the first preferred embodiment of the present invention. An image pick-up device 1 shown in FIG. 1 may include a camera control unit 11, a camera manipulation unit 12, a lens 13, an imaging unit 14, an image processing unit 15, a memory unit 16, a display unit 17, and a memory card 18. The image processing unit 15 may include a display control block 50. The memory card 18, which is a component of the image pick-up device 1 shown in FIG. 1, is configured to be attachable to and detachable from the image pick-up device 1, and need not be a configuration unique to the image pick-up device 1.

The lens 13 is an imaging lens that forms an optical image of a subject on an imaging plane of the imaging unit 14 when the driving of a focus lens provided within the lens 13, the driving of a diaphragm mechanism, the driving of a shutter mechanism, or the like is controlled by the camera control unit 11.

The imaging unit 14 includes a solid-state imaging element, which photoelectrically converts the optical image of the subject formed by the lens 13, and outputs an image signal (digital signal) corresponding to light of the subject to the image processing unit 15.

The image processing unit 15 performs various digital image processing for image signals. The image processing unit 15 may include the display control block 50, which generates display image data (hereinafter referred to as a “display image”) for displaying image data on the display unit 17, reads image data stored in the memory unit 16 via the camera control unit 11, generates the display image based on the read image data, and outputs the generated display image to the display unit 17. For example, the image processing unit 15 may include a recording control block, which generates recording image data for recording an image signal, and stores the generated image data in the memory unit 16 via the camera control unit 11. A configuration of the display control block 50 provided in the image processing unit 15 and a method of generating a display image in the display control block 50 will be described later.

For example, the memory unit 16 may be a storage device, which temporarily stores data, such as a synchronous dynamic random access memory (SDRAM), and temporarily stores various data in a processing process of the image pick-up device 1 when access is controlled by the camera control unit 11. For example, the memory unit 16 temporarily stores image data, which is output from the image processing unit 15 and input via the camera control unit 11. For example, the memory unit 16 temporarily stores image data, which is output from the memory card 18 and input via the camera control unit 11.

The display unit 17 may include, for example, a display device such as an LCD, and displays an image based on the display image generated by the display control block 50 within the image processing unit 15. The display unit 17 displays a still image captured by the image pick-up device 1 or reproduces (displays) an image stored in the memory card 18.

The memory card 18 is a recording medium for storing a still image captured by the image pick-up device 1. The memory card 18 records image data of a still image generated by a recording control block within the image processing unit 15.

The camera manipulation unit 12 is a manipulation unit for allowing a user of the image pick-up device 1 to input various manipulations to the image device 1. Examples of a manipulation member included in the camera manipulation unit 12 include a power switch for turning on/off a power supply of the image pick-up device 1, a release button for inputting an instruction for the image pick-up device 1 to capture a still image (or image a subject), an imaging mode switch for switching an imaging mode of the image pick-up device 1, or the like. The camera manipulation unit 12 outputs manipulation information to the camera control unit 11 when the user manipulates the above-described manipulation members.

The camera control unit 11 controls the entire image pick-up device 1. The camera control unit 11 outputs a control signal to the memory unit 16 such as a control signal for causing the memory unit 16 to store recording image data input from the image processing unit 15 or a control signal for causing the image processing unit 15 to read image data stored in the memory unit 16. Also, the camera control unit 11 outputs a control signal to the memory card 18 such as a control signal for causing the memory card 18 to store image data by reading the image data stored in the memory unit 16 or a control signal for causing the memory unit 16 to store image data by reading the image data of a still image stored in the memory card 18.

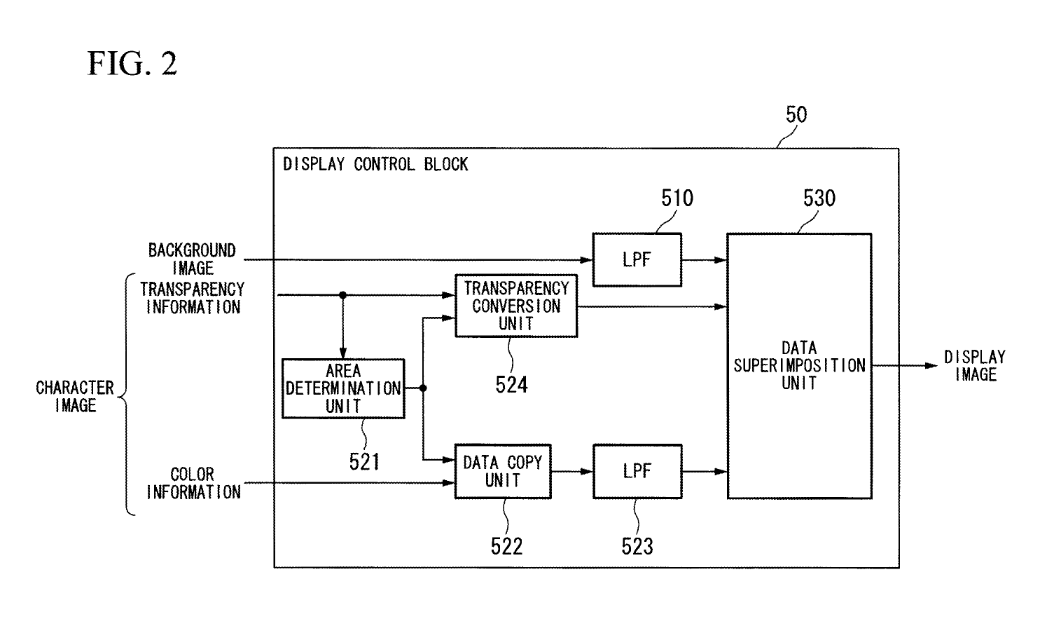

Next, the display control block included in the image processing unit within the image pick-up device in accordance with the first preferred embodiment of the present invention will be described. FIG. 2 is a block diagram showing a schematic configuration of the display control block 50 included in the image processing unit 15 within the image pick-up device 1 in accordance with the first preferred embodiment of the present invention. The display control block 50 shown in FIG. 2 includes an LPF 510, an area determination unit 521, a data copy unit 522, an LPF 523, a transparency conversion unit 524, and a data superimposition unit 530.

For example, the display control block 50 in accordance with the first preferred embodiment of the present invention reads recording image data or image data of a still image stored in the memory unit 16 from the memory unit 16 by a direct memory access (DMA) or the like. The read image data is stored in a background memory unit (not shown) as a background image. The display control block 50 generates a display image by superimposing, for example, a character image stored in a character memory unit (not shown) or the memory unit 16, on the background image stored in the background memory unit. The generated display image is output to the display unit 17 and displayed on the display unit 17.

The background image input to the display control block 50 has color data indicating a pixel color for each pixel of the background image. The character image input to the display control block 50 includes color information having color data indicating a pixel color for each pixel for a character portion and transparency information indicating whether or not each pixel of the same rectangular image as the background image is transparent.

The LPF 510 is a low pass filter that performs a filter process for the background image. The LPF 510 outputs the filtered background image to the data superimposition unit 530.

The area determination unit 521 determines a pixel area of the character portion in the character image based on the transparency information included in the character image. More specifically, a transparent pixel area (hereinafter referred to as a “transparent area”) and a non-transparent pixel area (hereinafter referred to as a “non-transparent area”) are determined based on a position of a pixel indicated to be transparent and a position of a pixel indicated to be non-transparent in the transparency information, and information indicating a pixel position of a boundary portion therebetween is acquired. The area determination unit 521 outputs information indicating a pixel position at a furthest end within the non-transparent area in the boundary portion between the transparent area and the non-transparent area as pixel information of a boundary area of the character (hereinafter referred to as “character boundary information”) to the data copy unit 522 and the transparency conversion unit 524.

If pixel information indicating that a pixel is semi-transparent is included in the transparency information to be included in the character image, the area determination unit 521 also handles a pixel indicated to be semi-transparent as a pixel indicated to be non-transparent. The area determination unit 521 determines a pixel area of the character portion in the character image based on the transparent area and a non-transparent area including an area of pixels indicated to be semi-transparent (hereinafter referred to as a “semi-transparent area”), and outputs character boundary information, which is information of pixels of a boundary area of the character determined, to the data copy unit 522 and the transparency conversion unit 524.

The data copy unit 522 generates new color information by copying color data of pixels of the character portion to be included in the character image based on the character boundary information input from the area determination unit 521. More specifically, color data of pixels located at the furthest end within the non-transparent area to be included in the character boundary information is copied to color data of pixels of an adjacent transparent area. Thereby, new color information is generated in which color data of pixels at the furthest end within the non-transparent area in the boundary portion between the transparent area and the non-transparent area is copied to pixels at the furthest end in the transparent area of the boundary portion between the transparent area and the non-transparent area.

The number of pixels for which the data copy unit 522 copies color data into the transparent area is decided according to a filter characteristic (the number of taps) of the LPF 523. More specifically, the same number as the number of pixels to be used for a filter process located before or after a pixel to be filtered by the LPF 523 becomes the number of pixels for which color data is copied into the transparent area. The data copy unit 522 copies color data corresponding to the number of pixels decided according to the number of taps of the LPF 523. For example, if the LPF 523 is a 3-tap LPF, color data is copied to one pixel at the furthest end of the transparent area because the filter process is performed using one pixel before or after the pixel to be filtered. For example, if the LPF 523 is a 5-tap LPF, color data is copied to one pixel at the furthest end of the transparent area because the filter process is performed using two pixels before or after the pixel to be filtered, and color data is further copied to one adjacent pixel, that is, color data is copied to two pixels at the furthest end of the transparent area.

As described above, for example, new color information is generated in a state in which an area of the character portion to be included in the character image is further increased, by copying color data corresponding to the number of pixels decided according to the number of taps of the LPF 523. The data copy unit 522 outputs the generated new color information (hereinafter referred to as “color copy information”) to the LPF 523 as color information of the character image to be filtered. The LPF 523 is a low pass filter for performing a filter process for the character image. The LPF 523 performs a filter process for the color copy information input from the data copy unit 522, and outputs the filtered color copy information to the data superimposition unit 530. The LPF 510 and the LPF 523 may have the same number of taps as each other or different numbers of taps from each other.

The transparency conversion unit 524 generates new transparency information by converting pixels of the character portion to be included in the character image into semi-transparent pixels based on the character boundary information input from the area determination unit 521. More specifically, transparency information of non-transparent pixels located in a predetermined range at the furthest end within the non-transparent area to be included in the character boundary information is converted into semi-transparency. Thereby, it is possible to synthesize pixels, which are located around the character portion as semi-transparent pixels, with the background image. The number of pixels of an area of pixels converted by the transparency conversion unit 524 into semi-transparency (hereinafter referred to as a “semi-transparent area”) is preset by the camera control unit 11. A semi-transparency rate of pixels to be converted by the transparency conversion unit 524 into semi-transparency is also preset by the camera control unit 11. The number of pixels and a semi-transparency rate of the semi-transparent area, which are set to the transparency conversion unit 524 by the camera control unit 11, can not only be preset to the image device 1 in accordance with the first preferred embodiment of the present invention, but can also be set by manipulation of the camera manipulation unit 12 by the user of the image pick-up device 1.

As described above, new transparency information for each pixel of the character image including transparency, semi-transparency, and non-transparency information is generated. The transparency conversion unit 524 outputs the generated new transparency information to the data superimposition unit 530 as transparency information of the character image.

The data superimposition unit 530 superimposes the filtered color copy information input from the LPF 523 on the filtered background image input from the LPF 510 based on the transparency information to be included in the character image. When the data superimposition unit 530 superimposes the filtered color copy information, only filtered pixel color data corresponding to a position of a pixel indicated to be non-transparent in the transparency information of the character image is superimposed on the filtered background image. Furthermore, the data superimposition unit 530 mixes filtered pixel color data corresponding to a position of a pixel indicated to be semi-transparent in the transparency information of the character image with color data of the filtered color data of the background image according to the semi-transparency rate.

### First Color Information Generation Method

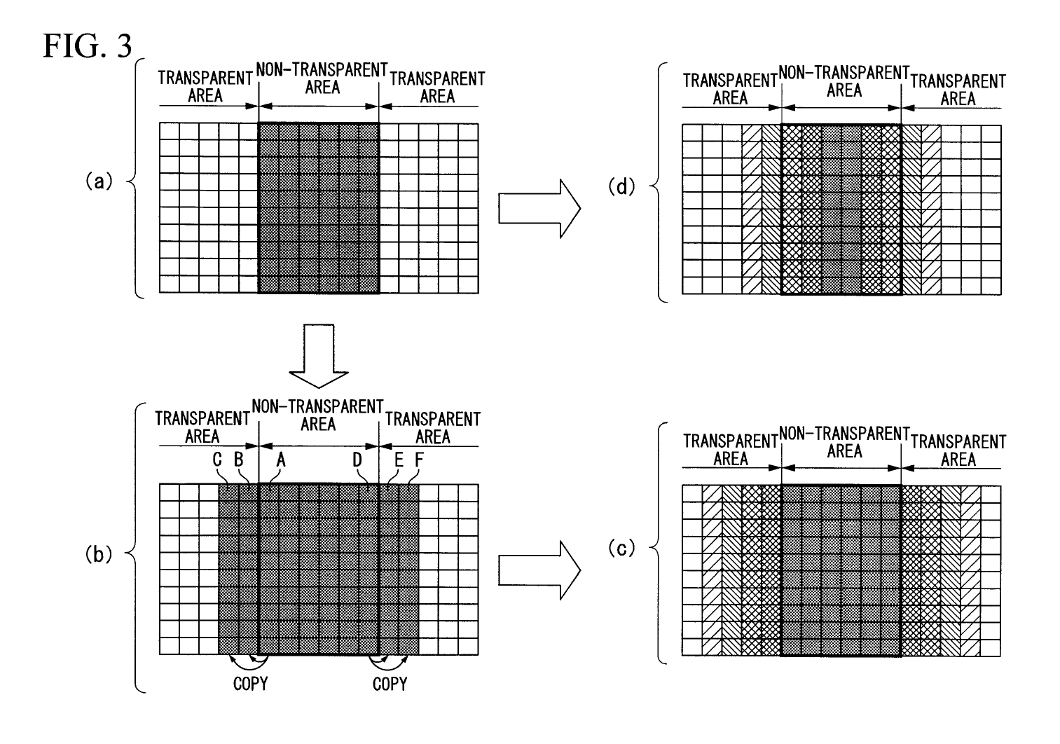

Next, a method of generating color information of a character image before filtering in the display control block in accordance with the first preferred embodiment of the present invention will be described. First, a basic idea when color copy information is generated using FIG. 3 will be described. FIG. 3 is a diagram illustrating the first color information generation method of generating the color information of the character image before a filter process in the display control block 50 in accordance with the first preferred embodiment of the present invention. In FIG. 3, only the color information is shown within the character image. FIG. 3 shows an example in which the LPF 523 performs the filter process only in a horizontal direction of the color information and the number of taps thereof is 5.

The data copy unit 522 copies color data of pixels for each row of the color information to be included in the character image based on character boundary information input from the area determination unit 521. This is because the LPF 523 performs the filter process in the horizontal direction of the color information.

More specifically, if the color information of the character image as shown in FIG. 3(a) is input to the display control block 50, the area determination unit 521 determines a boundary portion between the transparent area and the non-transparent area as shown in FIG. 3(a) based on transparency information to be included in the character image. As shown in FIG. 3(b), the data copy unit 522 copies pixel color data of a pixel A at a furthest end within the non-transparent area in one boundary portion (the left side of FIG. 3(b)) between the transparent area and the non-transparent area to pixels B and C in the transparent area of the boundary portion between the transparent area and the non-transparent area. Also, the data copy unit 522 copies pixel color data of a pixel D at the furthest end within the non-transparent area in another boundary portion (the right side of FIG. 3(b)) between the transparent area and the non-transparent area to pixels E and F in the transparent area of the boundary portion between the transparent area and the non-transparent area. The data copy unit 522 outputs color information as shown in FIG. 3(b) to the LPF 523 as color copy information.

The data copy unit 522 copies the color data of the pixel A to the two pixels B and C and copies the color data of the pixel D to the two pixels E and F in FIG. 3(b), but this is because the LPF 523 is the 5-tap LPF. That is, because the 5-tap LPF performs a filter process using two pixels before or after a pixel to be filtered, the data copy unit 522 copies the color data to the pixels B and C to be used to filter the pixel A and copies the color data to the pixels E and F to be used to filter the pixel D.

Thereafter, the filter process is performed by the LPF 523 and color information after the filter process as shown in FIG. 3(c) is obtained. FIG. 3(d) shows an example in which the color information of the character image as shown in FIG. 3(a) input to the display control block 50 is filtered by the LPF 523 without processing by the area determination unit 521 and the data copy unit 522. As seen from FIGS. 3(c) and 3(d), the color data of the non-transparent area of FIG. 3(d) is different from the color data shown in FIG. 3(a). However, as shown in FIG. 3(c), it is possible to obtain the color information after the filter process in which the color data of the non-transparent area is the same as the original color data shown in FIG. 3(a) by performing processing by the area determination unit 521 and the data copy unit 522.

Although the case where there is color data in all rows of color information to be included in the character image is shown in FIG. 3, the data copy unit 522 does not copy the color data because a row where there is no color data in the color information of the character image is not determined to be the non-transparent area by the area determination unit 521.

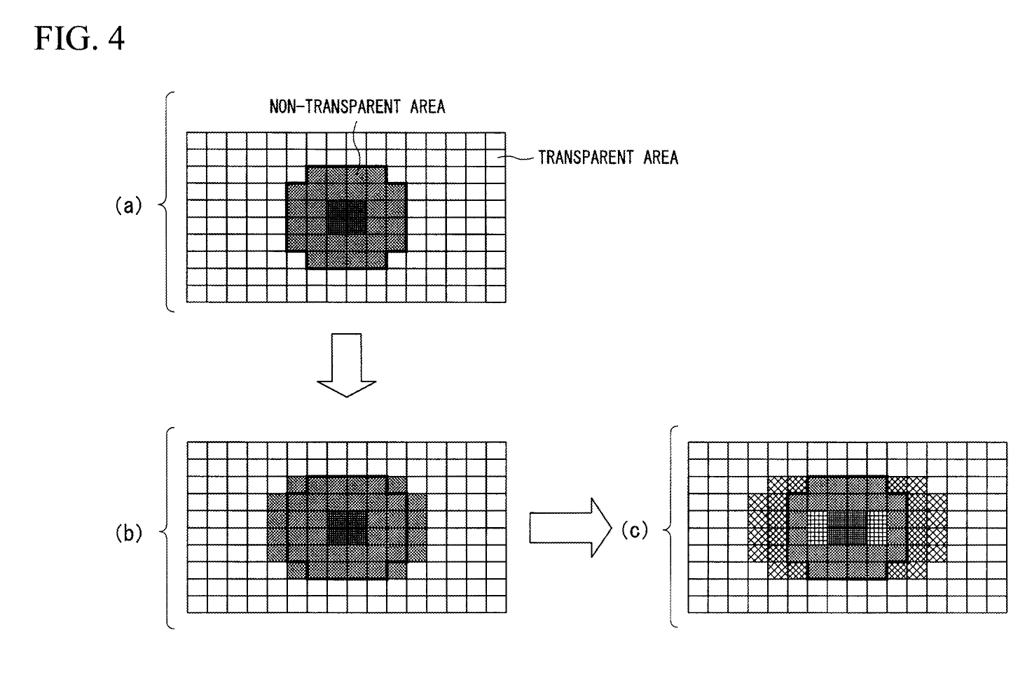

Here, a more specific example when the data copy unit 522 generates color copy information will be described using FIG. 4. FIG. 4 is a diagram schematically showing an example of color information of a character image generated in the first color information generation method by the display control block 50 in accordance with the first preferred embodiment of the present invention. In FIG. 4, only the color information is shown within the character image. FIG. 4 shows an example in which the LPF 523 performs only the filter process in a horizontal direction of the color information and the number of taps thereof is 3.

In the following description, a pixel position is indicated by XY coordinates, wherein the first number within parentheses ( ) is a column number of a pixel and the last number is a row number of the pixel, so that a position of each pixel within the color information can be easily identified. For example, a pixel located in a seventh column and a third row is expressed by a pixel (7, 3).

If the color information of the character image as shown in FIG. 4(a) is input to the display control block 50, the area determination unit 521 determines a boundary portion between a transparent area and a non-transparent area as shown in FIG. 4(a) based on transparency information included in the character image.

As shown in FIG. 4(b), the data copy unit 522 copies color data of pixels at the furthest end within the non-transparent area in one boundary portion of the horizontal direction between the transparent area and the non-transparent area to pixels at the furthest end in an adjacent transparent area in the horizontal direction in the boundary portion between the transparent area and the non-transparent area for each row of the color information. Also, the data copy unit 522 copies color data of pixels at the furthest end within the non-transparent area in another boundary portion of the horizontal direction between the transparent area and the non-transparent area to pixels at the furthest end in an adjacent transparent area in the horizontal direction in the boundary portion between the transparent area and the non-transparent area for each row of the color information.

More specifically, in one boundary portion of the horizontal direction (the left side of FIG. 4(b)), the data copy unit 522 copies color data of a pixel (7, 3) to a pixel (6, 3), copies color data of a pixel (6, 4) to a pixel (5, 4), copies color data of a pixel (6, 5) to a pixel (5, 5), copies color data of a pixel (6, 6) to a pixel (5, 6), copies color data of a pixel (6, 7) to a pixel (5, 7), and copies color data of a pixel (7, 8) to a pixel (6, 8). In another boundary portion of the horizontal direction (the right side of FIG. 4(b)), the data copy unit 522 copies color data of a pixel (10, 3) to a pixel (11, 3), copies color data of a pixel (11, 4) to a pixel (12, 4), copies color data of a pixel (11, 5) to a pixel (12, 5), copies color data of a pixel (11, 6) to a pixel (12, 6), copies color data of a pixel (11, 7) to a pixel (12, 7), and copies color data of a pixel (10, 8) to a pixel (11, 8).

The data copy unit 522 copies color data of pixels of each row pixel by one pixel in each of two sides of a boundary portion between the transparent area and the non-transparent area in FIG. 4(b), but this is because the LPF 523 is a 3-tap LPF, that is, because the filter process is performed using one pixel before or after a pixel to be filtered. The data copy unit 522 outputs the color information as shown in FIG. 4(b) to the LPF 523 as color copy information.

Thereafter, the filter process is performed by the LPF 523. As shown in FIG. 4(c), it is possible to obtain the color information after the filter process in which the color data of the non-transparent area is the same as the original color data shown in FIG. 4(a).

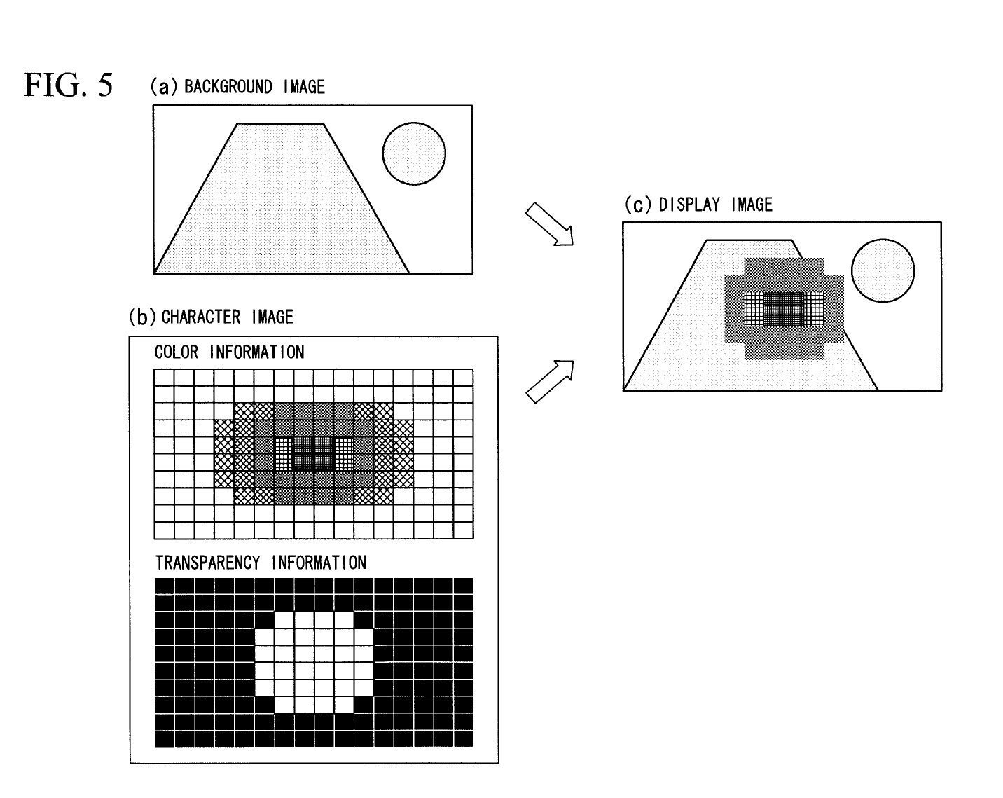

Next, a method of generating a display image in the display control block in accordance with the first preferred embodiment of the present invention will be described. FIG. 5 is a diagram schematically showing an example in which a display image is generated by synthesizing a background image with a character image generated by the first color information generation method in the display control block 50 in accordance with the first preferred embodiment of the present invention. FIG. 5 shows necessary image data and information when a synthesized display image is generated. FIG. 5(a) shows the background image, FIG. 5(b) shows color information of the character image and transparency information of the character image, and FIG. 5(c) shows the display image after synthesis. In order to facilitate the description in FIG. 5, an example in which new transparency information is not generated by the transparency conversion unit 524 will be described.

In the following description, the case where the character image as shown in FIG. 4(a) is input to the display control block 50 will be described. Accordingly, the filtered background image and the filtered color information (color copy information) shown in FIG. 4(c) are input to the data superimposition unit 530 of the display control block 50. The color information of the character image shown in FIG. 5(b) is the color information of FIG. 4(c), which is color information filtered using a 3-tap LPF in the horizontal direction, so as to reduce a false color occurring when the display image is displayed on the display unit 17 for the color copy information of FIG. 4(b). In the transparency information of the character image shown in FIG. 5(b), a black pixel area indicates a transparent area and a white pixel area indicates a non-transparent area.

As shown in FIG. 5(c), the display image in which the background image is synthesized with the character image is generated when color data of each pixel of the color information after the filter process corresponding to a pixel position indicating a non-transparent portion of the transparency information is superimposed on the filtered background image by the data superimposition unit 530. More specifically, the background image is made transparent by setting pixels of a transparent area shown in black in the transparency information to color data of pixels of the background image. The character image is synthesized by setting pixels of a non-transparent area shown in white to color data of pixels to be included in the color information.

As seen from FIG. 5(c), a false color due to the filter process in the character image does not appear in pixels of a boundary portion between the character image and the background image in the display image in which the background image is synthesized with the character image by the display control block 50. This is because it is possible to use filtered color information having the same color data as the original color information input to the display control block 50 as the character image to be superimposed on the background image, by the determination of the boundary portion between the transparent area and the non-transparent area by the area determination unit 521 and the copy of the color data corresponding to the number of taps of the LPF 523 by the data copy unit 522.

### Second Color Information Generation Method

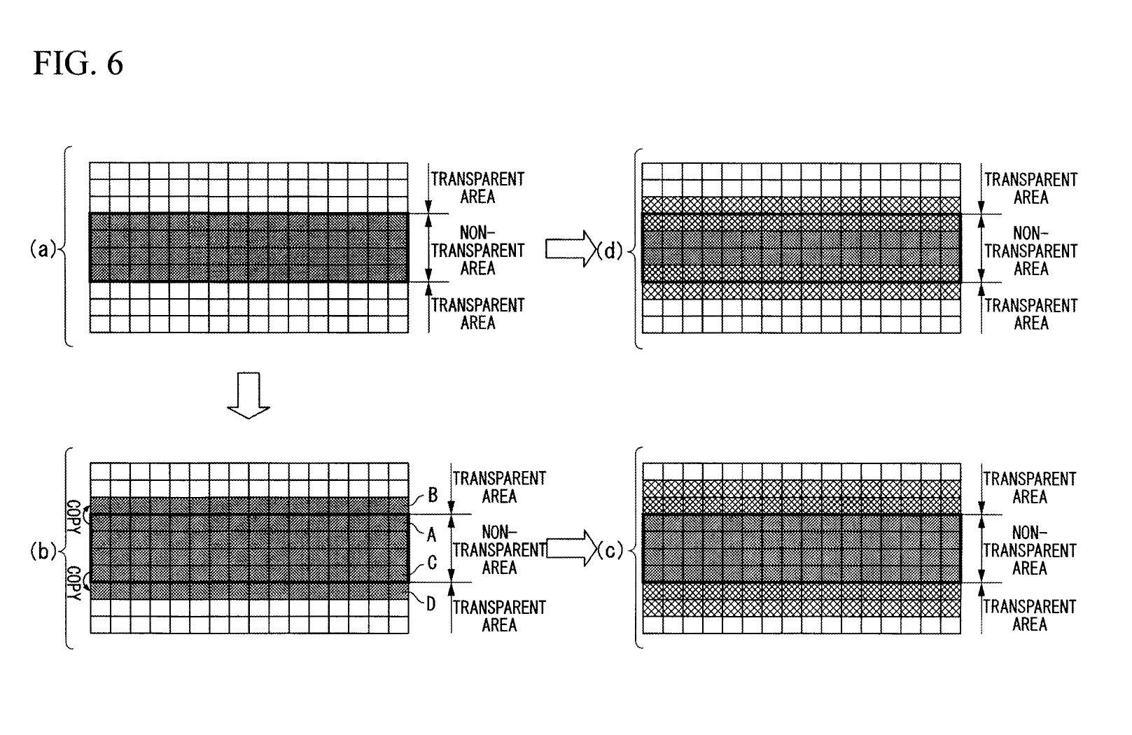

Next, another method of generating color information of a character image before a filter process in the display control block in accordance with the first preferred embodiment of the present invention will be described. While the above-described first color information generation method is a method of generating color information in an LPF that performs a filter process only in the horizontal direction of the color information, the second color information generation method is a method of generating color information in an LPF that performs a filter process only in a vertical direction of the color information. First, a basic idea when color copy information is generated will be described using FIG. 6. FIG. 6 is a diagram illustrating the second color information generation method of generating the color information of the character image before the filter process in the display control block 50 in accordance with the first preferred embodiment of the present invention. In FIG. 6, only the color information is shown within the character image. FIG. 6 shows an example in which the LPF 523 performs the filter process only in the vertical direction of the color information and the number of taps thereof is 3.

The data copy unit 522 copies pixel color data for each column of the color information to be included in the character image based on character boundary information input from the area determination unit 521. This is because the LPF 523 performs the filter process in the vertical direction of the color information.

More specifically, if the color information of the character image as shown in FIG. 6(a) is input to the display control block 50, the area determination unit 521 determines a boundary portion between a transparent area and a non-transparent area as shown in FIG. 6(a) based on transparency information to be included in the character image. As shown in FIG. 6(b), the data copy unit 522 copies pixel color data of a pixel A at the furthest end within the non-transparent area in one boundary portion (the upper side of FIG. 6(b)) between the transparent area and the non-transparent area to a pixel B in the transparent area of the boundary portion between the transparent area and the non-transparent area. Also, the data copy unit 522 copies pixel color data of a pixel C at the furthest end within the non-transparent area in another boundary portion (the lower side of FIG. 6(b)) between a transparent area and the non-transparent area to a pixel D in the transparent area of the boundary portion between the transparent area and the non-transparent area. The data copy unit 522 outputs color information as shown in FIG. 6(b) to the LPF 523 as color copy information.

The data copy unit 522 copies the color data of the pixel A to one pixel B and copies the color data of the pixel C to one pixel D in FIG. 6(b), but this is because the LPF 523 is the 3-tap LPF. That is, because the 3-tap LPF performs a filter process using one pixel before or after a pixel to be filtered, the data copy unit 522 copies the color data to the pixel B to be used to filter the pixel A and copies the color data to the pixel D to be used to filter the pixel C.

Thereafter, the filter process is performed by the LPF 523 and color information after the filter process as shown in FIG. 6(c) is obtained. FIG. 6(d) shows an example in which the color information of the character image as shown in FIG. 6(a) input to the display control block 50 is filtered by the LPF 523 without processing by the area determination unit 521 and the data copy unit 522. As seen from FIGS. 6(c) and 6(d), the color data of the non-transparent area of FIG. 6(d) is different from the color data shown in FIG. 6(a). However, as shown in FIG. 6(c), it is possible to obtain the color information after the filter process in which the color data of the non-transparent area is the same as the original color data shown in FIG. 6(a) by performing processing by the area determination unit 521 and the data copy unit 522.

Although the case where there is color data in all columns of color information to be included in the character image is shown in FIG. 6, the data copy unit 522 does not copy the color data because a column where there is no color data in the color information of the character image is not determined to be the non-transparent area by the area determination unit 521.

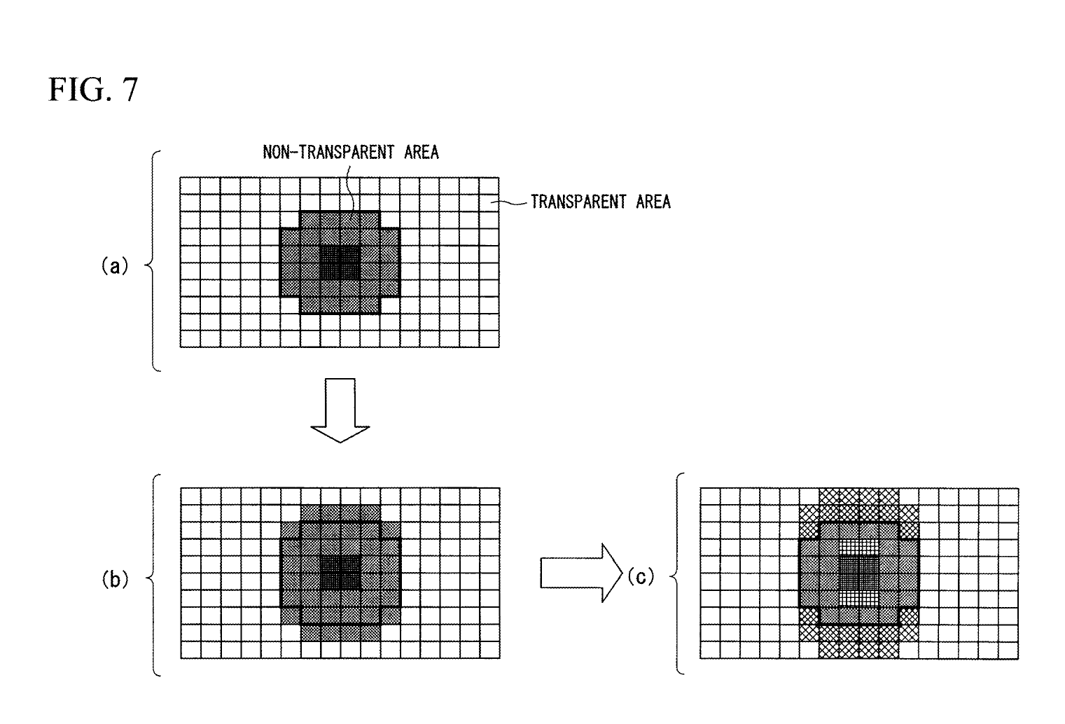

Here, a more specific example when the data copy unit 522 generates color copy information will be described using FIG. 7. FIG. 7 is a diagram schematically showing an example of color information of a character image generated in the second color information generation method by the display control block 50 in accordance with the first preferred embodiment of the present invention. In FIG. 7, only the color information is shown within the character image. FIG. 7 shows an example in which the LPF 523 performs the filter process only in the vertical direction of the color information and the number of taps thereof is 3.

In the following description, a pixel position is indicated by XY coordinates as in the example in which the color copy information shown in FIG. 4 is generated so that a position of each pixel within the color information can be easily identified.

If the color information of the character image as shown in FIG. 7(a) is input to the display control block 50, the area determination unit 521 determines a boundary portion between a transparent area and a non-transparent area as shown in FIG. 7(a) based on transparency information included in the character image.

As shown in FIG. 7(b), the data copy unit 522 copies color data of pixels at the furthest end within the non-transparent area in one boundary portion of the vertical direction between the transparent area and the non-transparent area to pixels at the furthest end in an adjacent transparent area in the vertical direction in the boundary portion between the transparent area and the non-transparent area for each column of the color information. Also, the data copy unit 522 copies color data of pixels at the furthest end within the non-transparent area in another boundary portion of the vertical direction between the transparent area and the non-transparent area to pixels at the furthest end in an adjacent transparent area in the vertical direction in the boundary portion between the transparent area and the non-transparent area for each column of the color information.

More specifically, as shown in FIG. 7(b), in one boundary portion of the vertical direction (the upper side of FIG. 7(b)), the data copy unit 522 copies color data of a pixel (6, 4) to a pixel (6, 3), copies color data of a pixel (7, 3) to a pixel (7, 2), copies color data of a pixel (8, 3) to a pixel (8, 2), copies color data of a pixel (9, 3) to a pixel (9, 2), copies color data of a pixel (10, 3) to a pixel (10, 2), and copies color data of a pixel (11, 4) to a pixel (11, 3). In another boundary portion of the vertical direction (the lower side of FIG. 7(b)), the data copy unit 522 copies color data of a pixel (6, 7) to a pixel (6, 8), copies color data of a pixel (7, 8) to a pixel (7, 9), copies color data of a pixel (8, 8) to a pixel (8, 9), copies color data of a pixel (9, 8) to a pixel (9, 9), copies color data of a pixel (10, 8) to a pixel (10, 9), and copies color data of a pixel (11, 7) to a pixel (11, 8).

The data copy unit 522 copies color data of pixels of each column pixel by one pixel in each of two sides of a boundary portion between the transparent area and the non-transparent area in FIG. 7(b), but this is because the LPF 523 is a 3-tap LPF, that is, because the filter process is performed using one pixel before or after a pixel to be filtered. The data copy unit 522 outputs the color information as shown in FIG. 7(b) to the LPF 523 as color copy information.

Thereafter, the filter process is performed by the LPF 523. As shown in FIG. 7(c), it is possible to obtain the color information after the filter process in which the color data of the non-transparent area is the same as the original color data shown in FIG. 7(a).

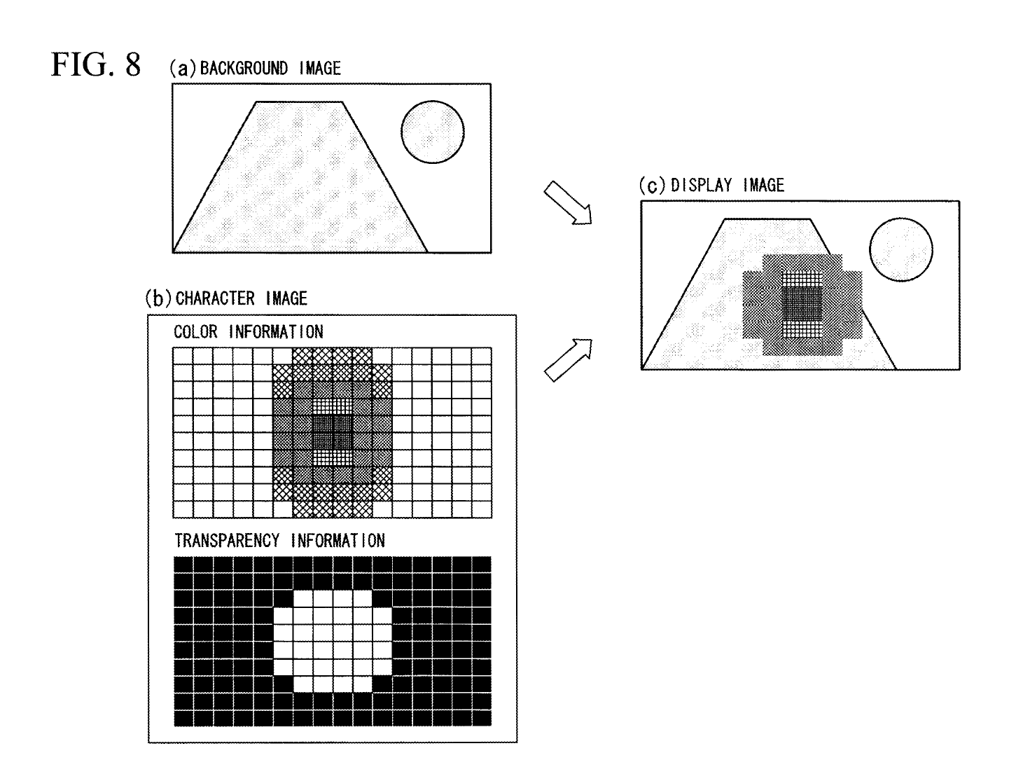

Next, a method of generating a display image in the display control block in accordance with the first preferred embodiment of the present invention will be described. FIG. 8 is a diagram schematically showing an example in which a display image is generated by synthesizing a background image with a character image generated by the second color information generation method in the display control block 50 in accordance with the first preferred embodiment of the present invention. FIG. 8 shows necessary image data and information when a synthesized display image is generated. FIG. 8(a) shows the background image, FIG. 8(b) shows color information of the character image and transparency information of the character image, and FIG. 8(c) shows the display image after synthesis. In order to facilitate the description in FIG. 8, an example in which new transparency information is not generated by the transparency conversion unit 524 will be described.

In the following description, the case where the character image as shown in FIG. 7(a) is input to the display control block 50 will be described. Accordingly, the filtered background image and the filtered color information (color copy information) shown in FIG. 7(c) are input to the data superimposition unit 530 of the display control block 50. The color information of the character image shown in FIG. 8(b) is the color information of FIG. 7(c), which is color information filtered using a 3-tap LPF in the vertical direction, so as to reduce a false color occurring when the display image is displayed on the display unit 17 for the color copy information of FIG. 7(b). In the transparency information of the character image shown in FIG. 8(b), a black pixel area indicates a transparent area and a white pixel area indicates a non-transparent area as in the example in which the display image shown in FIG. 5 is generated.

As shown in FIG. 8(c), the display image in which the background image is synthesized with the character image is generated when color data of each pixel of the color information after the filter process corresponding to a pixel position indicating a non-transparent portion of the transparency information is superimposed on the filtered background image by the data superimposition unit 530 as the example in which the display image shown in FIG. 5 is generated. More specifically, the background image is made transparent by setting pixels of a transparent area shown in black in the transparency information to color data of pixels of the background image. The character image is synthesized by setting pixels of a non-transparent area shown in white to color data of pixels to be included in the color information.

As seen from FIG. 8(c), a false color due to the filter process in the character image does not appear in pixels of a boundary portion between the character image and the background image in the display image in which the background image is synthesized with the character image by the display control block 50. This is because it is possible to use filtered color information having the same color data as the original color information input to the display control block 50 as the character image to be superimposed on the background image, by the determination of the boundary portion between the transparent area and the non-transparent area by the area determination unit 521 and the copying of the color data corresponding to the number of taps of the LPF 523 by the data copy unit 522.

### Method of Generating Transparency Information

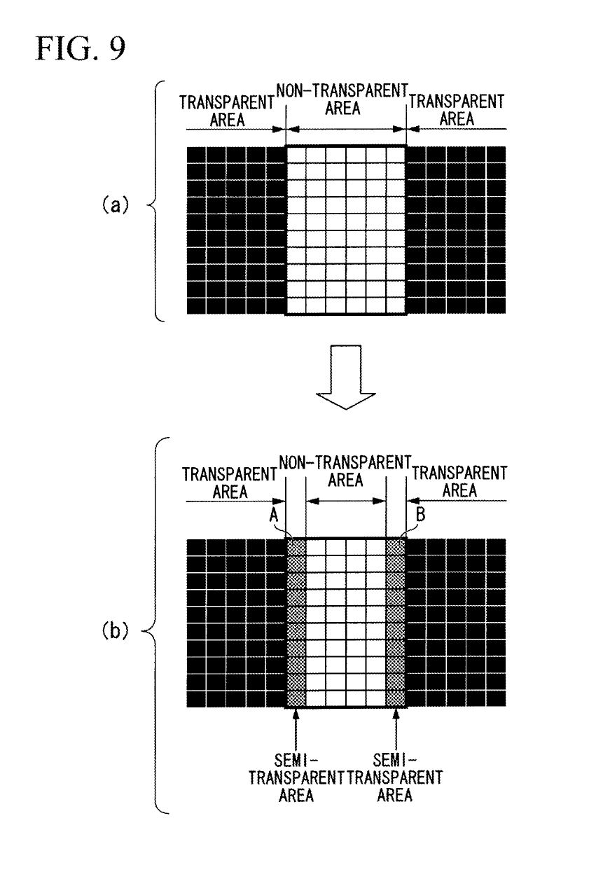

Next, the method of generating transparency information of a character image in the display control block in accordance with the first preferred embodiment of the present invention will be described. First, a basic idea of generating the transparency information will be described using FIG. 9. FIG. 9 is a diagram illustrating a method of generating the transparency information of the character image in the display control block 50 in accordance with the first preferred embodiment of the present invention. In FIG. 9, only the transparency information is shown within the character image.

An example in which the LPF 523 performs the filter process only in the horizontal direction of the character image will be described in the following transparency information generation method. Because it is possible to interchange the horizontal direction and the vertical direction as in the above-described first and second color information generation methods, a detailed description of the case where the filter process is performed only in the vertical direction of the character image will be omitted.

The transparency conversion unit 524 converts a pixel in which the transparency information of an input character image indicates non-transparency into a semi-transparent pixel based on character boundary information input from the area determination unit 521 and the number of pixels of the semi-transparent area and a semi-transparency rate set by the camera control unit 11.

More specifically, if the transparency information of the character image as shown in FIG. 9(a) is input to the display control block 50 and the number of pixels of the semi-transparent area is set to “1” by the camera control section 11, the area determination unit 521 determines a boundary portion between the transparent area and the non-transparent area as shown in FIG. 9(a) based on the transparency information to be included in the character image as in the color information generation method shown in FIG. 3. As shown in FIG. 9(b), the transparency conversion unit 524 converts one pixel (pixel A) at the furthest end within the non-transparent area in one boundary portion (the left side of FIG. 9(b)) between the transparent area and the non-transparent area into a pixel of the semi-transparent area. Also, the transparency conversion unit 524 converts one pixel (pixel B) at the furthest end within the non-transparent area in another boundary portion (the right side of FIG. 9(b)) between the transparent area and the non-transparent area into a pixel of the semi-transparent area.

Also, the transparency conversion unit 524 sets the semi-transparency rate in the pixels A and B to be converted into pixels of the semi-transparent area to a semi-transparency rate set by the camera control unit 11. The transparency information including semi-transparency information generated by the transparency conversion unit 524 indicates semi-transparency as well as transparency and non-transparency by a plurality of bits for each pixel of the character image. For example, in the case of the 8-bit transparency information, “0” is defined as a value indicating transparency, “1” to “254” are defined as values indicating semi-transparency, and “255” is defined as a value indicating non-transparency. A degree to which a pixel is semi-transparent is indicated by a gray scale of the transparency information. The transparency conversion unit 524 outputs the transparency information as shown in FIG. 9(b) to the data superimposition unit 530 as the transparency information of the character image.

The transparency conversion unit 524 sets two pixels A and B as pixels of the semi-transparent area in FIG. 9(b), but this is because the number of pixels of the semi-transparent area is set to “1” by the camera control unit 11 and the LPF 523 performs the filter process only in the horizontal direction of the character image.

Although the case where a pixel located in the transparent area and a pixel located in the non-transparent area are present in all rows of the transparency information to be included in the character image is shown in FIG. 9, a pixel located in the non-transparent area may not be in a row where there is no character image. In this case, a conversion into a semi-transparent pixel is not performed by the transparency conversion unit 524 because the area determination unit 521 does not determine that the area is the non-transparent area.

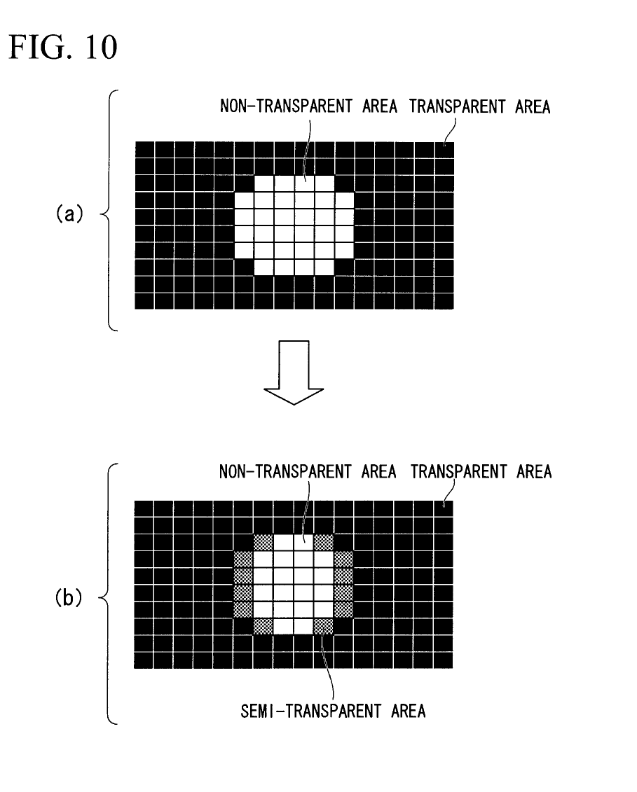

Here, a more specific example when the transparency conversion unit 524 generates transparency information will be described using FIG. 10. FIG. 10 is a diagram schematically showing an example of transparency information of a character image generated in a transparency information generation method by the display control block 50 in accordance with the first preferred embodiment of the present invention. In FIG. 10, only the transparency information is shown within the character image. FIG. 10 shows an example in which the LPF 523 performs a filter process only in the horizontal direction of the character image.

In the following description, a pixel position is indicated by XY coordinates as in the example in which the color copy information shown in FIGS. 4 and 7 is generated so that the position of each pixel within the transparency information can be easily identified.

If the transparency information of the character image as shown in FIG. 10(a) is input to the display control block 50 and the number of pixels of the semi-transparent area is set to “1” by the camera control unit 11, the area determination unit 521 determines a boundary portion between a transparent area and a non-transparent area as shown in FIG. 10(a) based on transparency information included in the character image.

As shown in FIG. 10(b), the transparency conversion unit 524 converts pixels at the furthest end within the non-transparent area in one boundary portion of the horizontal direction between the transparent area and the non-transparent area to pixels of the semi-transparent area for each row of the transparency information. Also, the transparency conversion unit 524 converts pixels at the furthest end within the non-transparent area in another boundary portion of the horizontal direction between the transparent area and the non-transparent area to pixels of the semi-transparent area for each row of the transparency information.

More specifically, as shown in FIG. 10(b), the transparency conversion unit 524 converts pixels (7, 3), (6, 4), (6, 5), (6, 6), (6, 7), and (7, 8) in one boundary portion (the left side of FIG. 10(b)) of the horizontal direction into pixels of the semi-transparent area. Also, the transparency conversion unit 524 converts pixels (10, 3), (11, 4), (11, 5), (11, 6), (11, 7), and (10, 8) in anther boundary portion (the right side of FIG. 10(b)) of the horizontal direction into pixels of the semi-transparent area.

The transparency conversion unit 524 performs a conversion into pixels of the semi-transparent area pixel by one pixel in each of two sides within the non-transparent area of each row in FIG. 10(b), but this is because the camera control unit 11 sets the number of pixels of the semi-transparent area to “1” and the LPF 523 performs a filter process only in the horizontal direction of the character image. The transparency conversion unit 524 outputs the transparency information as shown in FIG. 10(b) to the data superimposition unit 530 as the transparency information of the character image.

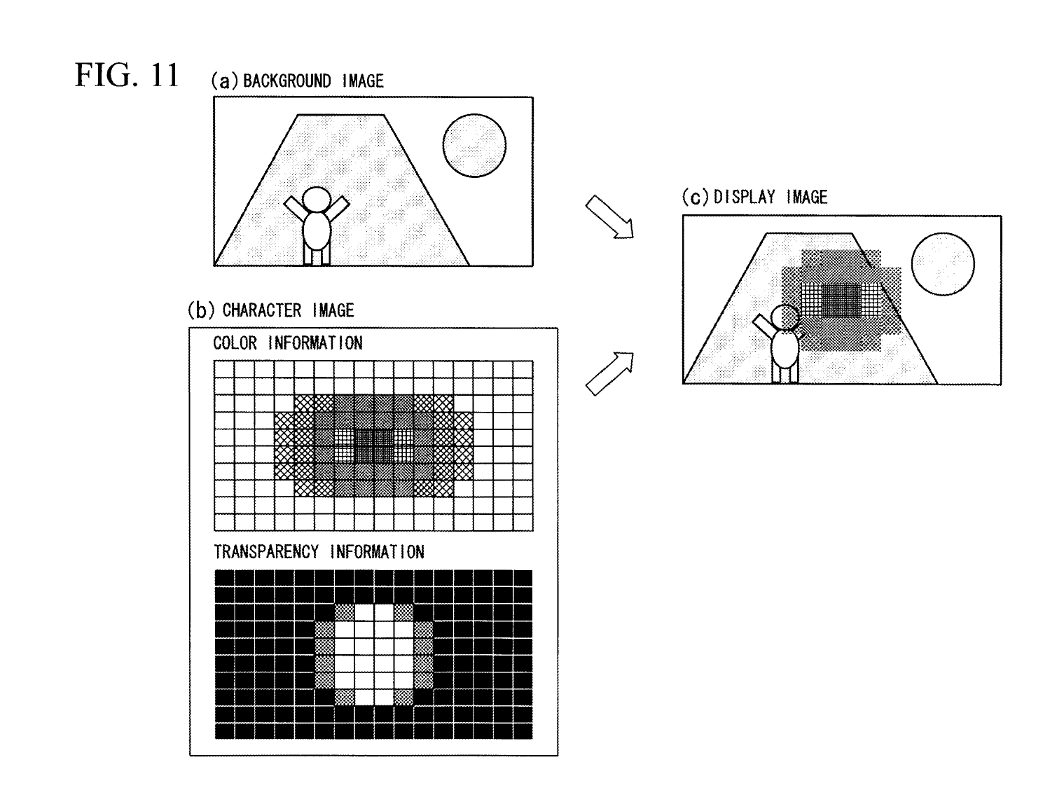

Next, a method of generating a display image in the display control block in accordance with the first preferred embodiment of the present invention will be described. FIG. 11 is a diagram schematically showing an example in which a display image is generated by synthesizing the background image with the character image obtained by processing the transparency information in the display control block 500 in accordance with the first preferred embodiment of the present invention. FIG. 11 shows necessary image data and information when a synthesized display image is generated. FIG. 11(a) shows the background image, FIG. 11(b) shows color information of the character image and transparency information of the character image, and FIG. 11(c) shows the display image after the synthesis.

In the following description, the case where the character image as shown in FIG. 4(a) is input to the display control block 50 as in the example in which the display image shown in FIG. 5 is generated will be described. Accordingly, the filtered background image and the filtered color information (color copy information) shown in FIG. 4(c) are input to the data superimposition unit 530 of the display control block 50. Like the color information of the character image shown in FIG. 5(b), the color information of the character image shown in FIG. 11(b) is color information of FIG. 4(c), which is color information filtered using a 3-tap LPF in the horizontal direction, so as to reduce a false color occurring when the display image is displayed on the display unit 17 with respect to the color copy information of FIG. 4(b). The transparency information of the character image shown in FIG. 11(b) is the transparency information shown in FIG. 10(b) generated by the transparency conversion unit 524. In the transparency information of the character image shown in FIG. 11(b), a pixel area indicated by hatching is a semi-transparent area, a black pixel area is a transparent area, and a white pixel area is a non-transparent area.

In the generation of the display image in which the background image is synthesized with the character image, color data of each pixel of the color information after the filter process corresponding to a pixel position indicating a non-transparent portion of the transparency information is superimposed on the filtered background image by the data superimposition unit 530 as shown in FIG. 11(c). Furthermore, color data of each pixel in the color information after the filter process corresponding to a pixel position indicating a semi-transparent portion in the transparency information is mixed with the filtered background image according to a semi-transparency rate. More specifically, the background image is made transparent by setting pixels of a transparent area shown in black in the transparency information to color data of pixels of the background image. The character image is synthesized by setting pixels of a non-transparent area shown in white in the transparency information to color data of pixels to be included in the color information. Furthermore, pixels of the semi-transparent area indicated by hatching in the transparency information are set to color data obtained by mixing the color data of each pixel of the background image with color data of each pixel to be included in the color information according to the semi-transparency rate, so that a semi-transparent character image is synthesized.

As seen from FIG. 11(c), a false color due to the filter process in the character image does not appear in pixels of a boundary portion between the character image and the background image in the display image in which the background image is synthesized with the character image by the display control block 50. This is because it is possible to use filtered color information having the same color data as the original color information input to the display control block 50 as the character image to be superimposed on the background image, by the determination of the boundary portion between the transparent area and the non-transparent area including the semi-transparent area by the area determination unit 521 and the copy of the color data corresponding to the number of taps of the LPF 523 by the data copy unit 522.

Furthermore, as seen from FIG. 11(c), the pixels of the semi-transparent area have color data obtained by mixing the color data of the background image with the color data of the character image. As described above, an edge occurring in a boundary portion between the character image and the background image can be blurred by setting the color data of the semi-transparent area to semi-transparency (mixed color). Thereby, it is possible to obscure a false color due to the absence of a correlation with color information of two images and display a display image having the same visual effect as when processing of the LPF is entirely performed after the background image is synthesized with the character image.

As described above, the display control block 50 in accordance with the first preferred embodiment of the present invention can generate new color information by copying color data of pixels of a character portion according to a direction of the filter process and the number of taps of the LPF 523, which filters the character image, provided in the display control block 50. Thereby, it is possible to prevent the occurrence of a false color (a false color due to the filter process) by setting color data of pixels of the character image located in the non-transparent area to different color data influenced by a color of pixels located in the transparent area even when the color information is filtered. Thereby, it is possible to prevent the occurrence of a false color in pixels of a boundary portion between the character image and the background image in the display image even when the display image is generated by synthesizing the character image with the background image.

In the display control block 50 in accordance with the first preferred embodiment of the present invention, the transparency conversion unit 524 can convert pixels of a boundary portion between the background image and the character image (that is, a boundary portion between the transparent area and the non-transparent area in the character image) from non-transparency into semi-transparency.

Thereby, it is possible to obscure a false color in pixels of the boundary portion between the character image and the background image in the display image (a false color due to the absence of a correlation with color information of pixels) even when the display image is generated by synthesizing the background image filtered by the LPF 510 with the character image filtered by the LPF 523. Thereby, it is possible to obtain the same visual effect as when the entire display image is filtered by the LPF after the background image is synthesized with the character image even when an image that is not absolutely correlated with color information, like the background image and the character image, is synthesized.

According to the embodiment of the present invention as described above, it is possible to extend color information of a character image so as to eliminate a result of a filter process in which pixels located in the non-transparent area have elements of color data of pixels located in the transparent area according to a filter process by an LPF, which performs a filter process for the character image, provided in the display control block, and the number of taps of the filter. Thereby, it is possible to prevent color data of pixels of the character image located in the non-transparent area from being different color data influenced by a color of pixels located in the transparent area when the color information is filtered even when a filter process is performed for the character image configured by the color information and the transparency information. Thereby, it is possible to obtain the display image in which the character image is superimposed on the background image without displaying (or outputting) a false color occurring in a boundary portion between the transparent area and the non-transparent area upon filtering.

According to the preferred embodiment of the present invention, it is possible to convert the transparency of a boundary portion between the background image and the character image (that is, a boundary portion between a pixel area of a transparent portion and a pixel area of a non-transparent portion in the character image) from non-transparency into semi-transparency. Thereby, it is possible to obscure a false color caused by superimposing two different images that are not absolutely correlated with image color information. Thereby, it is possible to prevent a false color occurring in the boundary portion between the transparent area and the non-transparent area upon filtering from being displayed (or output) even when the display image generated by synthesizing the character image with the background image after a separate filter is performed for the character image is displayed.

Although the case where the LPF 523 performs a filter process only in the horizontal or vertical direction of the color information has been described in the first preferred embodiment of the present invention, the direction of the filter process by the LPF 523 is not limited to the embodiment of the present invention. For example, the LPF 523 may be an LPF that performs a filter process in the horizontal and vertical directions of the color information. Likewise, this case can be applied, for example, by performing a process of a combination of the first color information generation method (based on the horizontal direction) and the second color information generation method (based on the vertical direction) described above.

Although an example in which one character image is superimposed on the background image has been described in the first preferred embodiment of the present invention, the number of character images to be superimposed on the background image is not limited to the embodiment of the present invention and a plurality of character images can be superimposed on the background image. In this case, in terms of each of the area determination unit 521, the data copy unit 522, the LPF 523, and the transparency conversion unit 524, which are components for processing the character image shown in FIG. 2, for example, a plurality of units of which the number is the number of character images to be superimposed can be included in the display control block 50. The present invention can be implemented by superimposing color information of character images after the respective filter processes by the data superimposition unit 530. The present invention can be implemented, for example, when one area determination unit 521, one data copy unit 522, one LPF 523, and one transparency conversion unit 524 sequentially process character images, and the data superimposition unit 530 sequentially superimposes color information of the character images after the filter process.

Although an example in which one character is included in the character image, that is, an example in which one non-transparent area is in the transparency information, has been described in the first preferred embodiment of the present invention, the number of characters included in the character image is not limited to the embodiment of the present invention. It is also possible to process a plurality of characters, that is, a plurality of non-transparent areas, within one character image. In this case, the area determination unit 521 determines pixel areas of portions of a plurality of characters in the character image, and outputs character boundary information, which is pixel information of boundary areas of the plurality of characters determined, to the data copy unit 522 and the transparency conversion unit 524. The data copy unit 522 generates new color information by copying color data for each boundary area of each character included in the input character boundary information. The transparency conversion unit 524 converts the transparency information of non-transparent pixels into semi-transparency for each boundary area of each character included in the input character boundary information. The data superimposition unit 530 superimposes a plurality of characters included in new color information, so that the present invention can be implemented.

Although the case where color information and transparency information of the character image are respectively input in different data formats has been described in the first preferred embodiment of the present invention, the data formats of the color information and the transparency information are not limited to the embodiment of the present invention. For example, there may be a format in which information of a plurality of bits is provided for each pixel of the character image and the bits indicate color information and transparency information. Likewise, this case can be applied by performing processing in correspondence with color information and transparency information of the first preferred embodiment for each bit.

While preferred embodiments of the present invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the claims.

What is claimed is:

1. A display control apparatus comprising:
an area determination unit that determines a boundary position of a superimposition image based on transparency information, the transparency information indicating whether or not each pixel, which is included in the superimposition image, is processed as a transparent pixel, the superimposition image being superimposed on a background image;
a color extension unit that extends an area of color information based on the boundary position determined by the area determination unit, the color information indicating a color of each pixel that is included in the superimposition image, the color extension unit outputting extension color information that has been extended;
a transparency conversion unit that converts information of pixels, which are to be processed as non-transparent pixels, in the transparency information based on the boundary position determined by the area determination unit, the transparency conversion unit outputting transparency conversion information including the information that has been converted; and
an image superimposition unit that superimposes color information after the extension color information output by the color extension unit is filtered based on the transparency conversion information, the image superimposition unit outputting a superimposed image as a display image.

2. The display control apparatus according to claim 1, wherein
the area determination unit divides pixels within the superimposition image into a transparent area to be processed as transparent pixels and a non-transparent area to be processed as non-transparent pixels based on the transparency information, and the area determination unit determines a boundary position between the transparent area and the non-transparent area within the superimposition image,
the color extension unit extends an area of color information of each pixel within the superimposition image by converting a color of a pixel of the superimposition image within the transparent area adjacent to the boundary position into a color of a pixel of the superimposition image within the non-transparent area adjacent to the boundary position,
the transparency conversion unit converts information of a pixel of the superimposition image within the non-transparent area adjacent to the boundary position in the transparency information into information to be processed as a semi-transparent pixel based on predetermined conversion information, and
the image superimposition unit directly sets a color of a pixel indicated to be processed as a transparent pixel by the transparency conversion information to a color of a corresponding pixel in the filtered background image, converts a color of a pixel indicated to be processed as a non-transparent pixel by the transparency conversion information into a color of a corresponding pixel in the filtered extension color information, and superimposes the superimposition image on the background image by converting a color of a pixel indicated to be processed as a semi-transparent pixel by the transparency conversion information into a color based on a color of a corresponding pixel in the filtered background image and a color of a corresponding pixel in the filtered extension color information.

3. The display control apparatus according to claim 2, wherein
the image superimposition unit comprises:
a first low pass filter (LPF) that performs a filtering process on the background image; and
a second LPF that performs a filtering process on the extension color information, and
the color extension unit decides the number of pixels of the superimposition image to be extended based on the number of taps of the second LPF provided in the image superimposition unit, and converts a color of pixels corresponding to the decided number and including a pixel of the superimposition image within the transparent area adjacent to the boundary position into a color of pixels of the superimposition image within the non-transparent area adjacent to the boundary position.

4. The display control apparatus according to claim 2, wherein
the transparency information comprises information indicating whether or not each pixel within the superimposition image is processed as a semi-transparent pixel, and the area determination unit designates a pixel indicated to be processed as the semi-transparent pixel by the transparency information as a non-transparent pixel, and determines a boundary position between the transparent area and the non-transparent area including the semi-transparent pixel.

5. The display control apparatus according to any one of claims 3 and 4, wherein
the second LPF performs a filter process in a horizontal direction of the superimposition image, and
the color extension unit extends an area of color information of each pixel within the superimposition image in the horizontal direction by converting a color of a pixel of the horizontal direction in the superimposition image within the transparent area adjacent to the boundary position into a color of a pixel of the horizontal direction in the superimposition image within the non-transparent area adjacent to the boundary position.

6. The display control apparatus according to any one of claims 3 and 4, wherein
the second LPF performs a filter process in a vertical direction of the superimposition image, and
the color extension unit extends an area of color information of each pixel within the superimposition image in the vertical direction by converting a color of a pixel of the vertical direction in the superimposition image within the transparent area adjacent to the boundary position into a color of a pixel of the vertical direction in the superimposition image within the non-transparent area adjacent to the boundary position.

7. The display control apparatus according to claim 1, wherein the transparency conversion unit converts the information of pixels, which are to be processed as non-transparent pixels, in the transparency information into information to be processed as semi-transparent pixels based on the boundary position determined by the area determination unit, and the transparency conversion unit outputs the transparency conversion information including the information that has been converted.

8. The display control apparatus according to claim 1, wherein the image superimposition unit superimposes the color information after the extension color information output by the color extension unit is filtered on a background image after the background image is filtered based on the transparency conversion information, and the image superimposition unit outputs the superimposed image as the display image.

9. A display control method comprising:
an area determination step of determining a boundary position of a superimposition image based on transparency information indicating whether or not each pixel to be included in the superimposition image to be superimposed on a background image is processed as a transparent pixel;
a color extension step of extending an area of color information indicating a color of each pixel to be included in the superimposition image based on the boundary position determined by the area determination step, and outputting extended extension color information;
a transparency conversion step of converting information of pixels to be processed as non-transparent pixels in the transparency information based on the boundary position determined by the area determination step, and outputting transparency conversion information including the converted information; and
an image superimposition step of superimposing color information after the extension color information output by the color extension step is filtered based on the transparency conversion information, and outputting a superimposed image as a display image.

10. The display control method according to claim 9, wherein in the transparency conversion step, the information of pixels, which are to be processed as non-transparent pixels, in the transparency information is converted into information to be processed as semi-transparent pixels based on the boundary position determined in the area determination step, and the transparency conversion information including the information that has been converted is output.

11. The display control method according to claim 9, wherein in the image superimposition step, the color information after the extension color information output in the color extension step is filtered is superimposed on a background image after the background image is filtered based on the transparency conversion information, and the superimposed image is output as the display image.
